(19) United States
(12) Patent Application Publication
(10) Pub. No.: US 2014/0380446 A1
(43) Pub. Date: Dec. 25, 2014

(54) METHOD AND APPARATUS FOR PROTECTING BROWSER PRIVATE INFORMATION

(71) Applicant: Tencent Technology (Shenzhen) Co., Ltd., Shenzhen (CN)

(72) Inventors: Dongsheng Niu, Shenzhen (CN); Jinggang Lu, Shenzhen (CN)

(73) Assignee: Tencent Technology (Shenzhen) Co., Ltd., Shenzhen (CN)

(21) Appl. No.: 14/226,343

(22) Filed: Mar. 26, 2014

Related U.S. Application Data
(63) Continuation of application No. PCT/CN2013/090518, filed on Dec. 26, 2013.

(30) Foreign Application Priority Data
May 23, 2013 (CN) 2013101961711

(51) Int. Cl. H04L 29/06

(52) U.S. Cl. CPC H04L 63/0861
USPC 726/7

(57) ABSTRACT

A method and apparatus for protecting browser private information have been disclosed. The method including: detecting a viewing request to view private information of a current browser page; obtaining a current user's face image upon detecting the viewing request; determining based on a pre-set face recognition method, whether the current user's facial image and a registered user's face image bear same face print features, wherein the face print features are utilized to uniquely identify facial features of a person; and displaying the private information of the browser page, in response to a positive determination of bearing the common face print features.

### CROSS-REFERENCE TO RELATED APPLICATIONS

The application is a continuation of PCT Application No. PCT/CN2013/090518, filed on Dec. 26, 2013, which claims priority to Chinese Patent Application No. 2013101961711, filed on May 23, 2013, which is incorporated by reference in their entireties.

### FIELD OF THE TECHNOLOGY

The invention belongs to the field of browser technology; in particular, it involves a method and apparatus for protecting browser private information.

### BACKGROUND

Mobile phone privacy protection issue has been one of the biggest concerns among users. With the development of mobile phones as a daily important Internet access tool, a user may access bank accounts, pay bills, purchase on-line, access social media websites and access emails through the mobile phone, such as a smart phone. Such personal information and web browsing history are considered as private and they may be subjected to identity theft or invasion of privacy if inadvertently revealed to an unintended party (e.g., a friend borrowing the mobile phone to access Internet) or to an unauthorized party (e.g., a stolen phone).

Therefore, mobile phone users are increasingly concerned about the security of private information in their mobile phones, and how to protect the browser private information has become a concern that should not be ignored. Private information of a browser may include: favorites, bookmarks, browsing history which link to the websites accessed by the owner of the mobile phone and other sensitive information, to name a few.

Existing mobile phone browser, however, do not have privacy protection features. Therefore, once the mobile phone is accessed by others, the owner's personal private information may be compromised. Some mobile phones use password or biometric identification (i.e., finger print) to lock the phone to protect the phone from being accessed by an unauthorized user. Nevertheless, once the phone is unlocked to an authorized user (e.g., lending a phone to a friend or a guest for use), the private information of the browser page of the owner of the mobile phone is still unprotected from the friend or the guest. Likewise, the browser access history of the friend or guest is also unprotected to the owner of the phone.

### SUMMARY

The embodiments of this invention manifest a browser private information protection method and mechanism aimed at addressing the issues of existing browser private information protection method, namely being cumbersome in operation and password prone to be forgotten.

An aspect of the present disclosure provides a method for protecting browser private information. The method may include: detecting a viewing request to view private information of a current browser page; obtaining a current user's face image upon detecting the viewing request; determining based on a pre-set face recognition method, whether the current user's facial image and a registered user's face image bear same face print features, wherein the face print features are utilized to uniquely identify facial features of a person; and displaying the private information of the browser page, in response to a positive determination of bearing the common face print features.

Another aspect of the present disclosure provides an apparatus for protecting browser private information. The apparatus may include: at least a processor operating in conjunction with at least a memory which stores instruction codes operable as plurality of units, wherein the plurality of units may include: a request detection unit which detects a viewing request to view private information of a current browser page; an image acquisition unit which obtains a current user's face image upon detecting the viewing request; and a privacy protection unit which determines based on a pre-set face recognition method, whether the current user's facial image and a registered user's face image bear same face print features, wherein the face print features are utilized to uniquely identify facial features of a person; and displays the private information of the browser page, in response to a positive determination of bearing the common face print features.

Yet another aspect of the present disclosure provides a non-transitory computer-readable medium having stored thereon, a computer program having at least one code section being executable by a machine which causes the machine to perform steps for protecting browser private information, including: detecting a viewing request to view private information of a current browser page; obtaining a current user's face image upon detecting the viewing request; determining based on a pre-set face recognition method, whether the current user's facial image and a registered user's face image bear same face print features, wherein the face print features are utilized to uniquely identify facial features of a person; and displaying the private information of the browser page, in response to a positive determination of bearing the common face print features.

The embodiment of the present disclosure achieves the dynamic adaptation of the hardware environment for a client by sending the hardware environment information of the client to the server and acquiring configuration parameters matching the hardware environment from the server, and making the client adapt the hardware environment by combining the dynamic configuration information preset at the client with the configuration parameters, so that the client can provide better user experiences by calling hardware functions of a terminal device.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 is an exemplary flow chart illustrating a method for protecting browser private information, according to an embodiment of the disclosure.

FIG. 2 is an exemplary structural diagram of an apparatus which carries out the method as shown in FIG. 1, according to an embodiment of the disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features may be referenced back to the prior descriptions in a prior numbered drawing or referenced ahead to a higher numbered drawing.

In order to clarify the object, technical scheme and advantages of the present disclosure more specifically, the present disclosure is illustrated in further details with the accompanied drawings and embodiments. It should be understood that the embodiments described herein are merely examples to illustrate the present disclosure, not to limit the present disclosure.

The various embodiments of the disclosure implements existing face recognition technology. Face recognition technology is an emerging biometric technology which has been developed and continues to be refined with the help of high speed processing to perform statistical analysis algorithms in order to converge mapping results between face print features from a submitted face image with face print features of face images from people of known identity stored in a database.

Exemplary face recognition algorithms may include utilizing local characteristics analysis algorithm which integrates computer imaging processing technology and bio-statistical theory to extract facial features from an image frame taken from a video camera or from a still camera on a smart phone, a laptop computer, a tablet computer or through a web camera of a terminal. The face recognition algorithm thus utilizes a principle of biometrics to analyze and establish mathematical statistical models for authentication by comparing how close a match on the face print features between a submitted face image and the one or more face images stored in a database. If the statistical model exceeds a certain threshold of similarity with a particular face image in the database, the submitted face image may be identified to assume the same identity of the matched face image in the database, and access to the browser protection information may be granted. Otherwise, access will be denied and a notice will be sent.

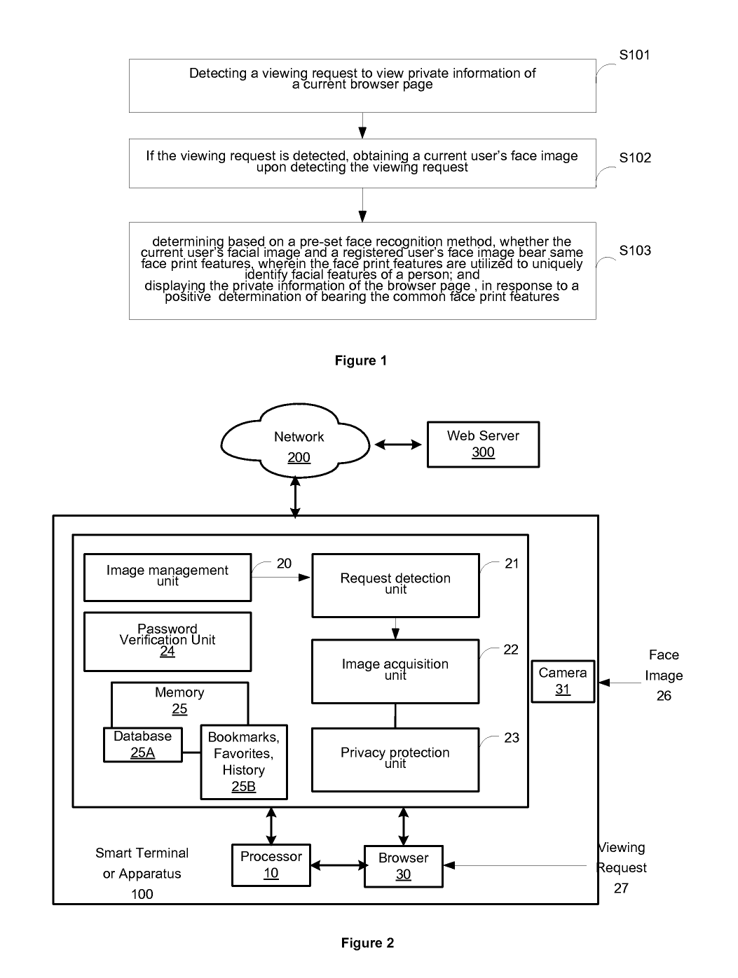

FIG. 1 is an exemplary flow chart illustrating a method for protecting browser private information, according to an embodiment of the disclosure. FIG. 2 may be referenced to for the sake of convenience in describing the processes in the flow chart.

In Step S101, detecting a viewing request (27) (see FIG. 2) to view private information (25B) of a current browser page. In an embodiment, a current browser page may refer to the browser's user interaction page in a smart terminal (100) (also referred to as apparatus (100) in FIG. 2), wherein the private information (25B) of the browser page may include but is not limited to favorites, bookmarks and browsing history of the user. A viewing request (26) may be a command used by a current user (the current user may be the owner of the terminal (100), a guest of the owner of the terminal (100) or an unauthorized person) to trigger a display of the private information (25B) of the browser page. The display of the private information (25B) on the browser (30) may enable the current user to access websites linked to the bookmarks, the favorites, or from the browsing history. Alternately, the display of the private information (25B) may also enable the current user to perform one or more of the following: to add or to delete the contents in the bookmarks, the favorite and the browsing history, etc.

Smart terminals (100), such as a smart phone, a tablet, a notebook computer, a laptop computer, a desk top computer or any terminal which is enabled to connect to a network (200) to access a webserver (300). The smart terminal (100) may possess capabilities to detect in a real-time manner any viewing requests (27) for the private information (25B) of the current browser page.

In the embodiment of the disclosure, as an alternative, before detecting a viewing request (27) for private information (25B), the smart terminal may be configured or enabled to add or delete a registered face image in a database (25A). The registered face image may be a face image of an authorized user stored in a database format. More specifically, the current user's facial image (26) may be acquired through a camera (31) or generated from a user's pictures, which may be saved along with the face print code generated based on the facial image in the database (25A).

Specifically, the setting, adding or deleting of the registered face image may include: receiving a permission management command which may include prompting to enter identity information for identity authentication. For example, the registered user may be prompted to enter his name, birth date, a password or any information that may help to establish the identity of the registered user of the smart terminal (100).

After passing identity authentication, two possible scenarios may occur. In a first scenario, an image configuration command may be received and face scanning on a face image (26) of the registered user may begin to obtain and store into the database (25A), the scanned face image (26) of the registered user plus any additional requirements that may help to identify the registered user. More specifically, the scanned face image may include some dynamic and complex background scenery which may complicate or render inaccurate identification of the person's face image. Therefore, such dynamic and complex background scenery may need to be filtered out in order to isolate the relevant portion of the face image for identification.

There are several ways to isolate the face image portion from a scanned picture for face image identification. Some of these methods may include: reference template method, face pattern method, adaptive sample learning method, skin color models method and sub-facial characteristics method, etc. In practice, some of all of the above-mentioned five methods may be combined to isolate and render a highly recognizable and identifiable face image.

In a second scenario after passing the identity authentication, provide an image deletion command to the smart terminal (100) to delete the addition requirements that needs to be met in the stored registered face image according to the owner of the terminal or user's specified need.

In Step S102, obtaining a current user's face image (26) upon detecting the viewing request (27). The captured current user's face image (26) may be utilized by the smart terminal (26) as the current user's face image for identifying or authenticating the user's identity. For example, if the viewing request (27) is detected, the smart terminal (100) may capture the current user's face image (26) in real time, via a camera (31) on the smart terminal (100). This may be a preferred image capturing method for most situations.

Alternately, the user's face image (26) may be input to the smart terminal by means of a designated photograph or picture which bears the current user's face image. This alternate image capturing method may be used in case there is a concern that the face image of the owner of the smart terminal (100) or the authorized user may change over a short period of time, such as suffering a facial injury, wearing make ups, or other events that may cause the current user's face to change or differ from before. In this situation, the current user (who is authorized to access the private information (25B) may designate a particular picture of himself or herself (which may be stored as an image file in a device, or as a physical picture) to be used for image input so that no other pictures of the current user may be used to gain unauthorized access to the private information (25B) of the current browser page on the smart terminal (100).

In Step S103, determining based on a pre-set face recognition method, whether the current user's facial image and a registered user's face image bear same face print features, wherein the face print features are utilized to uniquely identify facial features of a person; and displaying the private information of the browser page, in response to a positive determination of bearing the common face print features.

More specifically, the pre-set face recognition method may include at least one or more methods to isolate the relevant face image portion from the background scenery, and to extract face print features from the face image (26). The face print features may include: shape of the face, relative separations between eye brows, lips dimensions, presence of scar, marks on the face, cheek bone location, skin color of the face, nose shape, jaw shape, eyes color, forehead dimensions or any facial features that may be used as metrics for matching from the database (25A) to establish the identity and to authenticate the current user through the current face image (26).

In addition, the pre-set face recognition method may compare and match the face print features of the registered user's face image stored in the database (25A), and determine whether the current user's facial image (26) and the registered user's face image (stored in the database 25A) may bear same face print features by statistical analysis. If yes, displaying the private information (25B) of the browser page to be viewed by the current user; if not, rejecting the viewing request (27), and notify the current user.

No matter which comparison method may be utilized, the face recognition method compares the face print features of the current face image against the face images in the database (25A). The method may include utilizing feature vector and face print template. The feature vector method may determine the properties of iris, nose, mouth and other facial features, such as size, location and distance, etc.; and then calculate their geometric characteristic quantities to form the metrics to characterize the face.

The face print template method may store in the database some standard face templates or face image templates. During comparison, all pixels of the sampled face image may be matched with all templates in the database by a normalized correlation metrics method. A statistical calculation is performed to determine how close a match may be found.

Alternately, another method may combine the autocorrelation network or characteristics that uses pattern recognition with the template. If the face image and registered face image bears a close match to the same face print, the user is authenticated and the private information of the current browser page may be displayed to be viewed by the user. If the face image and registered face image do not have bear a close match to the same face print, the viewing request may be denied.

Nevertheless, the disclosure in the above method may still utilize a backup authentication alternative, namely, using password authentication. This password backup authentication may be needed in case if the image recognition algorithm on the smart terminal may be corrupted due to a virus infection, or if the camera (31) malfunctions, or if the user fails to carry a designated picture for authentication.

The following description may provide another example of an application of the disclosed method using a mobile phone's browser (30) as the example: a user may pre-sets a registered face image with his or her face image from a picture or photograph. The mobile phone (100) may retrieve the registered face print, and save the registered face image and the face print. When the browser (30) receives a user's viewing request (27) for browsing history, the mobile phone (100) may start the front camera (31) to capture a current user's face image (26), or receive an existing face image specified by the user. The smart phone's browser (30) may isolate the face print from the face image and determine by the pre-set face recognition method. if the current user's facial image (26) has the same face print as that of the registered face image in the database (25A); private information (25B) of the current browser page may be viewed by the user; if not, reject the viewing request (27), and conduct identity verification or set up another registered face image (26) for the current user as a new authorized user.

In brief, the disclosure discloses a privacy protection method to prevent unauthorized access to the private information of the browser page, even other functions of the smart terminal: such as making phone calls, sending texts, or taking pictures may be made available. The same protection method may optionally be configured and implemented on the other functions (i.e., making phone calls, sending texts, or taking pictures) in a piece meal fashion on the smart terminal (100). Accordingly, the owner of the smart terminal may exercise control over what functions or information may be made accessible to guest users.

FIG. 2 is an exemplary structural diagram of an apparatus (100) which carries out the method as shown in FIG. 1, according to an embodiment of the disclosure. For the convenience of description, only the relevant part that is related to the embodiment of the invention may be showed.

The apparatus (100) for protecting browser private information may include at least a processor (10) operating in conjunction with at least a memory (25) which stores instruction codes operable as plurality of units, wherein the plurality of units may include: an image management unit (20), a request detection unit (21), an image acquisition unit (22), a privacy protection unit (23). The apparatus may also include a browser (30) and a camera (31). The memory (25) may include one or more than one memory units to store registered user's face images as a database (25A), and to store private information (25B) of the browser page. The apparatus (100) may also include a password verification unit (24) as a backup or default authentication tool.

The request detection unit (21) may detect a viewing request (26) to view private information (25B) of a current browser page.

The image acquisition unit (22) may obtain a current user's face image (26) (using a camera (31)) upon detecting the viewing request (27). Alternately, the image acquisition unit (22) may capture the current user's facial image (26) via receiving a selected facial image regarded as belonging to the current user, such as from a photograph or from an input image file via an external device, etc.

The privacy protection unit (23) may determine based on a pre-set face recognition method, whether the current user's facial image (26) and a registered user's face image (stored in a database (25A)) may bear same face print features, wherein the face print features are utilized to uniquely identify facial features of a person; and displays the private information (25B) of the browser page, in response to a positive determination of bearing the common face print features. If the face print features are the same as the registered user's face print features, display the private information (25B) of the current browser page to be viewed by the user; if not, reject the viewing request.

The password authentication unit (24) may be used for password authentication as a backup authentication tool.

The image management unit (20) may be used for setting the registered face image. Furthermore, the image management unit (20) may be used to set, add or delete the registered face image. The image management unit (20) may be used to prompt for the entry of the identity identifier (i.e., current user's name or password, etc.) and receive the identity identifier for identity authentication, when it receives the management command. If identity authentication passes, the image management unit may receive a command to set the image (26), conduct face scanning, and retrieve and store registered face image that meets the addition requirements; if the authentication is passed, it receives an image deletion command to delete the registered face image that meets the addition requirements.

The browser's private information protection apparatus illustrated in this embodiment of the disclosure may be applied to the method as described in FIG. 1. It should be noted that each unit in the above embodiment of the apparatus (100) may be divided by the function logic, which shall not be construed as the only way; it would be fine as long as they realize their corresponding function. In addition, the naming for each specific functional unit is just for the convenience of distinguishing them, which is not used to limit the protection scope of the invention.

It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive. ROM or flash memory. The computer-executable commands are used to enable a computer, server, a smart phone, a tablet or any similar computing device to accomplish the cross-platform video playing operations.

The foregoing represents only some preferred embodiments of the present disclosure and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

What is claimed is:

1. A method for protecting browser private information, comprising:
detecting a viewing request to view private information of a current browser page;
obtaining a current user's face image upon detecting the viewing request;
determining based on a pre-set face recognition method, whether the current user's facial image and a registered user's face image bear same face print features, wherein the face print features are utilized to uniquely identify facial features of a person; and
displaying the private information of the browser page, in response to a positive determination of bearing the common face print features.

2. The method according to claim 1, wherein the detecting of the viewing request to view the private information of the current browser page, comprising one of:
capturing the current user's facial image via a camera or receiving a selected facial image regarded as belonging to the current user.

3. The method according to claim 1, wherein the determining based on the pre-set face recognition method, whether the current user's facial image and the registered user's face image bear the same face print features, and the displaying of the private information of the browser page, in response to a positive determination of bearing the common face print features, comprising:
extracting face print features of the current user via the preset face recognition method;
reading face print features corresponding to the registered user's face image; and
determining whether the facial print features of the current user and the registered user being the same, and if so, displaying the private information of the browser page to be viewed by the current user; if not, rejecting the viewing request.

4. The method according to claim 3, wherein after rejecting of the viewing request to view the current browser page private information, comprising one or both of:
performing a password authentication; and
installing the registered user's face image.

5. The method according to claim 1, wherein prior to detecting the viewing request to view the current browser page private information, comprising:
installing or deleting the registered user's face image.

6. A apparatus for protecting browser private information comprises at least a processor operating in conjunction with at least a memory which stores instruction codes operable as plurality of units, wherein the plurality of units comprise:
a request detection unit which detects a viewing request to view private information of a current browser page;
an image acquisition unit which obtains a current user's face image upon detecting the viewing request; and
a privacy protection unit which determines based on a pre-set face recognition method, whether the current user's facial image and a registered user's face image bear same face print features, wherein the face print features are utilized to uniquely identify facial features of a person; and displays the private information of the browser page, in response to a positive determination of bearing the common face print features.

7. The Apparatus according to claim 6, wherein if the viewing request for browser page private information is detected, the image acquisition unit captures the current user's facial image via a camera or receiving a selected facial image regarded as belonging to the current user.

8. The Apparatus according to claim 6, wherein the privacy protection unit extracts face print features of the current user via the preset face recognition method;
reads face print features corresponding to the registered user's face image; and
determines whether the facial print features of the current user and the registered user being the same, and if so, displaying the browser page private information to be viewed by the current user; if not, rejecting the viewing request.

9. The Apparatus according to claim 8, further comprises:
a password authentication unit, which performs password authentication;
an image management unit, which installs the registered user's face image.

10. The Apparatus according to claim 6, wherein the image management unit installs or deletes the registered user's face image.

11. A non-transitory computer-readable medium having stored thereon, a computer program having at least one code section being executable by a machine which causes the machine to perform steps for protecting browser private information, comprising:
detecting a viewing request to view private information of a current browser page;
obtaining a current user's face image upon detecting the viewing request;
determining based on a pre-set face recognition method, whether the current user's facial image and a registered user's face image bear same face print features, wherein the face print features are utilized to uniquely identify facial features of a person; and
displaying the private information of the browser page, in response to a positive determination of bearing the common face print features.

12. The non-transitory computer-readable medium according to claim 11, wherein the detecting of the viewing request to view the current browser page private information, comprising one of:
capturing the current user's facial image via a camera or receiving a selected facial image regarded as belonging to the current user.

13. The non-transitory computer-readable medium according to claim 11, wherein the determining based on the pre-set face recognition method, whether the current user's facial image and the registered user's face image bear the same face print features, and the displaying of the private information of the browser page, in response to a positive determination of bearing the common face print features, comprising:
extracting face print features of the current user via the preset face recognition method;
reading face print features corresponding to the registered user's face image; and
determining whether the facial print features of the current user and the registered user being the same, and if so, displaying the private information of the browser page to be viewed by the current user; if not, rejecting the viewing request.

14. The non-transitory computer-readable medium according to claim 13, wherein after rejecting of the viewing request to view the current browser page private information, comprising one or both of:
performing a password authentication; and
installing the registered user's face image.

15. The non-transitory computer-readable medium according to claim 11, wherein prior to detecting the viewing request to view the current browser page private information, comprising:
installing or deleting the registered user's face image.
